(19) United States
(12) Patent Application Publication
(10) Pub. No.: US 2005/0243288 A1
(43) Pub. Date: Nov. 3, 2005

(54) Method and apparatus for a reduced thickness television display using shallow angle oblique projection

(76) Inventors: Baogang Wu, Beijing (CN); Jining Wu, Beijing (CN); Wei Zhang, Beijing (CN); Yukuan Li, Beijing (CN); Jianmi Gao, Beijing (CN); Zhixin Fan, Beijing (CN); Jingwu Wen, Beijing (CN); Tao Chen, Beijing (CN)

Correspondence Address: WILLIAM A. FIETZ, 5608 SANDALWOOD DRIVE, MCKINNEY, TX, 75070, US

(21) Appl. No.: 10/836,450

(22) Filed: Apr. 30, 2004

(51) Int. Cl. G03B 21/22

(52) U.S. Cl. 353/97

(57) ABSTRACT

A method and system for delivering a television display in a very thin cabinet is presented. The reduction of cabinet depth is achieved by the use of suitable optics to create an image ray that is full screen width but greatly reduced in the vertical direction. This beam is then directed at a very shallow oblique angle into the viewing screen system, which allows the viewer to observe the picture or display in its proper proportions.

### CROSS REFERENCE TO RELATED APPLICATIONS

Not Applicable

### FEDERALLY SPONSORED RESEARCH OR DEVELOPMENT

Not Applicable

### REFERENCE TO A MICROFICHE APPENDIX

Not Applicable

### BACKGROUND OF THE INVENTION

Projection Display: Among large-screen displays, there are various advantages for a projection display. It uses a very small imager such as LCoS, DMD, or P-Si-TFT LCD, with a diagonal of 0.5-1″, illuminated by an appropriate light source, through variousa optics (e.g. lenses etc.) to project to the screen. When compared with TFT LCD, PDP, and LED type of large screen displays, the projection display can easily achieve high resolution and high contrast at a lower price. Projection display can be categorized into front projection and rear projection types.

In front projection, the projection light source and the viewer are on the same side of the screen. The projected light and the ambient light are reflected and scattered in a similar way on the screen. The reflection and scattering of the ambient light on the screen and onto the viewer's eyes are unavoidable. So a high contrast ratio can only be achieved when the ambient light is weak.

In rear projection, the projection light source and the viewer are on the opposite sides of the screen. Specially designed screens are available that allow most of the projected light to pass through, but very little of the ambient light shining on the screen will reach the viewer's eyes. In this way, even in an area with strong ambient light, a high contrast ratio can be achieved.

In comparison with most other large screen flat panel displays, the main disadvantage of the rear projection display is a thick enclosure. Even after folding the light path multiple times, and using aspheric lenses, a thickness of about 10 inches is the best that can be achieved. Furthermore, in the process of making the display slim, the optics system becomes very complicated, with increased distortion, lowered light utilization, a relatively complex rear projection screen structure, and a higher price.

### Oblique Projection

In this invention, we use oblique projection to replace some of the ordinary lenses etc. for the purpose of image magnification. Using oblique projection, a display measuring only one to a few inches in thickness can be achieved. The whole system is simplified, and light utilization is increased.

### BRIEF SUMMARY OF THE INVENTION

The system proposed herein comprises seven components:
1. The light source,
2. The imager,
3. A beam conditioning device,
4. A composite vertical and horizontal cylindrical lens system,
5. Vertical aperture,
6. Horizontal aperture,
7. Beam redirecting and conditioning optics, and
8. A display cabinet with viewing screen system.

FIG. 1 shows the components in a schematic representation with the individual parts arranged linearly for clarity and identified according to the above numbering scheme. Of course, in any final arrangement the optical paths may be folded to make a more compact system.

More operating details will be found in a later section, but the operation of the system can be summarized as follows: A small, (diagonal of 0.5-1″) imager such as LcoS, DMD, or P-Si-TFT LCD, is illuminated by an appropriate parallel light source and beam conditioning system. The output from the imager, containing the signal information is focused by an optical system, perhaps an arrangement of two orthogonal cylindrical lenses that act independently on the horizontal and vertical components of the image. The beam is focused into a line by each of the cylindrical lenses/components which have different focal lengths to provide different magnification in the vertical and horizontal axes. At each of the focal points, the beam passes as a line through an aperture, which removes diffraction effects created by the imager, allowing only the main beam to pass. In the embodiment shown in the figure, the beam passes through the vertical aperture first, since the greater magnification is in the horizontal direction where the beam attains the full screen width of perhaps 40 inches for a screen with a 50 inch diagonal. The vertical component, on the other hand is only magnified by a minimal amount, perhaps attaining a height of 1-5 inches.

At the point where the beam has been magnified to the desired dimensions, the light beam must again be converted into parallel rays, i.e., a plane wave entering the TV cabinet. It is convenient to picture rays emerging from the imager as a ray from each individual pixel. With high quality optics, the relative position and spacing will be maintained throughout the various magnifications. Entering the first lens system (the orthogonal cylindrical lenses) there may be 1600 individual rays in a horizontal row and 1200 rows. At the entrance to the screen cabinet they will be distributed so that the horizontal array is the full width of the viewing screen but the vertical distribution is much less than the height of the screen. To achieve the necessary vertical spread, the beam enters the screen cabinet at a small angle so that the beam is now spread to the necessary vertical height. Methods for presenting the final picture to the viewer are covered in the detailed description.

### BRIEF DESCRIPTION OF THE DRAWINGS

FIG. 1 is schematic representation of a shallow angle oblique projection TV display set.

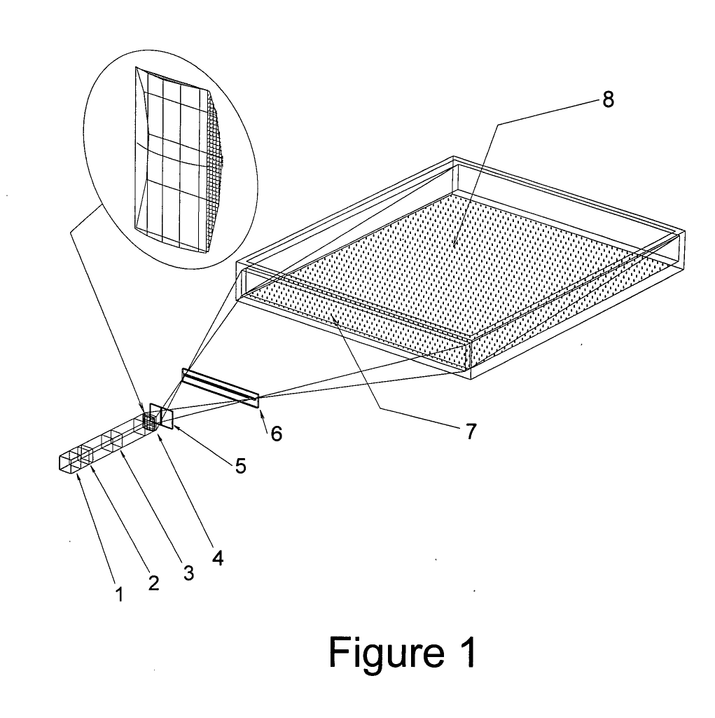

FIG. 2 is an oblique projection display using LcoS as an imager and a cylindrical mirror as the second optical system.

FIG. 3 is an oblique projection display using a two-dimensional cylindrical lens as the second optical system.

FIG. 4 is an oblique projection display using a semiconductor laser, a beam expander, and dichroic mirrors.

FIG. 5 is a front projection version of an oblique projection display.

FIG. 6 is a rear projection version of an oblique projection display.

FIG. 7 shows an alternative optical system using a spherical first lens and a circular aperture followed by a cylindrical lens and mirror.

### DETAILED DESCRIPTION OF THE INVENTION

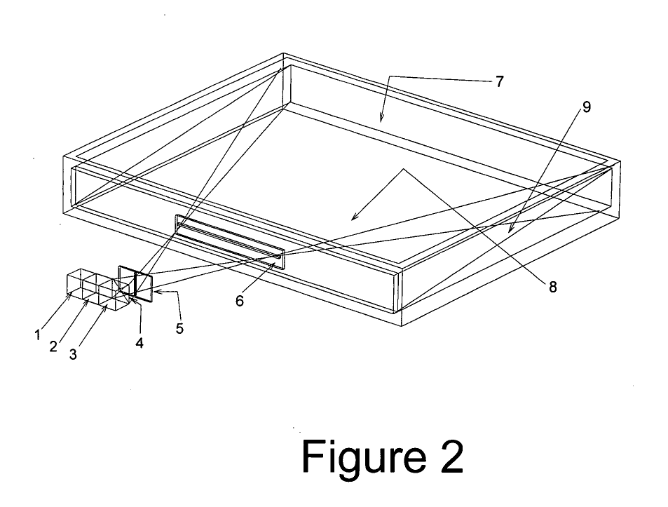

FIG. 2 illustrates the use of a LCoS as an imager for oblique projection display. Time-sequential red, green, and blue polarized parallel rays enter the polarizing beam splitter (PBS) (2), onto the LCoS. The image signal is modulated onto the parallel ray through the PBS, then onto a two-dimensional cylindrical lens (4). A two dimensional cylindrical lens is one wherein the rays in X and Y directions are independently focused at their respective focal distances of fx and fz. At fx and fy the respective vertical aperture (5) and horizontal aperture (6), eliminate diffraction from the imager. The main lobe of the focused rays passes through its respective aperture and expands in X and Z directions. Upon reaching the two-dimensional reflective cylindrical mirror (7), with its two focal distances of fx′ and fz′, the mirror surface and Z axis subtend an angle of α/2. After reflecting the light rays stop expanding, emerging as a parallel rectangular beam of width x and height z. The original image from the LCoS has expanded to a rectangular beam of width x′ and height z′. In other words the original image was magnified by Kx=fx′/fx in the X direction, and Kz=fz′/fz in the Z direction. This beam is projected onto the screen (8) at an angle α, with Z direction changing to Y direction, z′ becoming y′, Ky=y′/z′. Since α is very small, around one to a few degrees, the oblique projection magnification is Ky=1/α, where α is in radians.

In summary, the image is magnified by Kx=fx′/fx in the X direction, and magnified by K=Kz*Ky=(fz′/fz)*(1/α) in the Y direction. We design the display so that the two magnification factors Kx and K are the same, K=Kx, resulting in a proportional magnification of K times that of the image on the LCoS on the screen (8). The screen (8) vertically reflects the oblique rays onto the front screen (9), so that the magnified image scatters at a defined angle of visual dispersion. The display cabinet is slightly thicker than z′, only one to a few inches thick. The observer watching at roughly parallel to the Z direction obtains the most comfortable angle of view. In this kind of arrangement, the cylindrical mirror folds the light rays, making the system very compact.

If the imager is a DMD, then the time-sequential red, green, and blue rays need not be polarized, and the PBS is not necessary. If the imager is a P-Si-TFT LCD, then the time-sequential red, green, and blue polarized parallel rays pass through the LCD directly with modulation to the two-dimensional cylindrical lens (4).

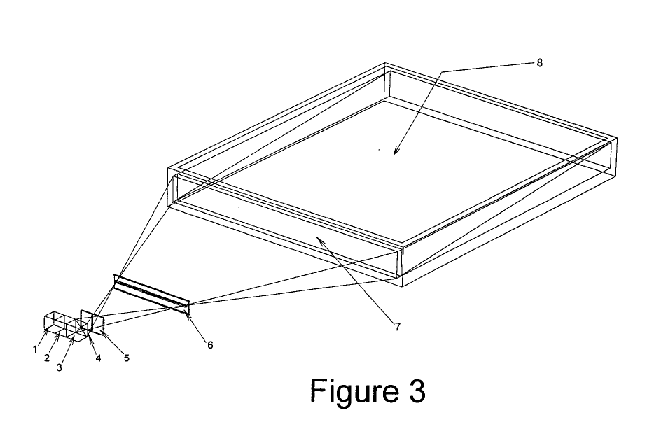

We can also use a two-dimensional cylindrical lens to replace the cylindrical mirror (7), placing the screen (8) behind the expanding parallel rectangular beam, with the surface of the screen and the parallel beam at an angle of α. The light rays are completely on-axis in this arrangement, with a disadvantage of a bigger box, as shown in FIG. 3.

### Light source

Requirements: Oblique projection requires very parallel red, green and blue rays. The switching speed has to be fast to support time-sequential full color display. The light has to be uniformly distributed on the projected surface. The light must be strong enough. The light source requires a small volume, light weight, a long life, a high light conversion efficiency, fast switching speed and a low cost.

Possible light source choices: Laser is an excellent parallel light. Through a beam expander, the laser beam can be expanded into uniform parallel beam.

The semiconductor laser has a small volume, is lightweight, has fast switching speed, and is cheap. If in the future there is a high power product in the market, the semiconductor laser is an excellent choice for the oblique projection display.

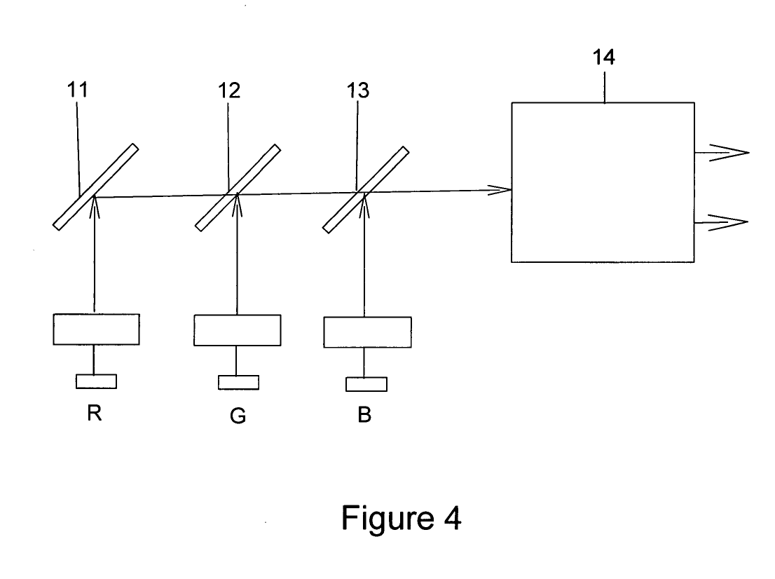

In FIG. 4, the red, green, blue semiconductor laser rays are reflected by the red, green, and blue dichroic mirrors, then expanded by the beam expander. This action produces a parallel light beam with similar size surface area as the imager, switched synchronously with the red, green and blue image to produce the necessary time-sequential color light source.

When the solid-state laser is in mass production, with a lowered price, it can also be used. A gas laser can produce polarized light, and can also be used, although it has a bigger volume.

Light Emitting Diodes, LED, can produce red, green and blue colors, have a fast switching speed, are cheap, with a small size, light weight, long life, with a high electric-light conversion efficiency. If we can get an LED with a high power output, yet with a small emitting junction, packaged into a point source, then we can use it for time-sequential light source for oblique projection display.

Ultra High Pressure, UHP and Xenon light sources have high power output and can be used as oblique projection light source as well. But we must select one with as small an emitting arc as possible in order to produce better parallel light. Because they are not a pure white light source, a color wheel is necessary. A better solution is to use the color light switch (see published application US2004/0031672A1) to turn them into color time-sequential light sources.

### Imager

The LCoS imager is small, can be manufactured with high resolution, low cost, needs a polarized light source, is reflective liquid crystal display, requiring PBS, the liquid crystal switching speed has to be fast to satisfy the requirement of time-sequential color display.

P-Si-TFT LCD modulates the parallel polarized light passing through, has a simple design, and the response time of the liquid crystal display need to be fast enough to meet the requirement of time-sequential color display. DMD can utilize non-polarized light, has high switching speed, can be simply implemented for oblique projection display, has high light utilization, but is expensive.

### Two-Dimensional Cylindrical Optics

There are two places in the oblique projection display where two-dimensional cylindrical optics may be used. In either place, it is conceivable to use either lenses or mirrors and the functions will be similar in the way they affect the system.

First is the two-dimensional cylindrical lens, (4) in FIGS. 2 and 3, with focal length of fx and fz respectively. The parallel light that has been modulated, from the imager LCoS, passes through the two-dimensional cylindrical lens, expands in two different angles, using fz>>fx, so expanding more in the X direction than the Z direction. When the rays reach the two-dimensional cylindrical mirror, (7) in FIG. 2, with focal lengths of fx′ and fz′ respectively, the X direction has been magnified sufficiently from x to x′, Kx=x′/x=fx′/fx, where Kx is the magnification ratio in the X direction, with nominal value in the two digits. The image in the Z direction has been magnified from z to z′, and the magnification ratio Kz=z′/z=fz′/fz, is only a few times. After the reflecting cylindrical mirror, the rays stop expanding, and become a parallel light beam of width x′ and height z′, obliquely projected onto the screen at an angle of α, so z′ is magnified to become y′, with the magnification ratio Ky=y′/z′=1/α, roughly more than ten times. Finally the image height z is magnified at the screen to become y′, the magnification ratio K=y′/z=Kz/Ky=Kz/α, selecting K=Kx will result in a magnified image with proper aspect ratio. Note that when (4) is a lens, to obtain the same focal length for different wavelengths of light we need a color-corrected two-dimensional cylindrical lens. (7) is a two-dimensional cylindrical mirror, and does not have a color-correction issue, it folds the light path, so the system is reduced in size by nearly half, with the thickness still z′, but subtending an angle of α/2 with the Z axis, so the incident light is off the main axis by an angle of α/2, resulting in a slight distortion, which can be compensated through careful design of the cylindrical mirror.

In FIG. 3, (7) is a two-dimensional cylindrical lens, the incident ray enters at the main axis, but requires a design with color correction. The screen and the parallel light coming from the cylindrical lens form an angle α. This design is bigger.

### Aperture

Two narrow apertures (or slits) (5) and (6) are used in FIGS. 2and 3, placed at the focal distances of the two two-dimensional cylindrical lenses in the X and Z direction, the distance between the vertical aperture (5) and the cylindrical lens (4) being fx, and that of the cylindrical lens (6) being fx′. Similarly, the distance between the horizontal aperture (6) and the cylindrical lens (4) is fz, and the cylindrical lens (7) is fz′. They must be positioned accurately, and the slits narrow enough to allow only the main lobe of the light beam coming from the image pixels to pass through, while eliminating the diffracted light coming from the imager, in order to increase the contrast ratio for the oblique projection.

### Screen for Oblique Projection

Requirements: The screen is a key component for an oblique projection display. It affects greatly light utilization, contrast ratio, and viewing angle. We would like the screen to transfer all of the obliquely projected light completely onto the side of the viewer perpendicular to the screen at a comfortable viewing angle range. At the same time, we would like to prevent the ambient light on the side of the viewer reaching the eyes of the viewer.

Structure: We categorize the screen into front-projection and rear-projection types.

Front projection: The viewer and the obliquely projected light are on the same side of the front projection screen. What is different from other front projection screens is that the obliquely projected parallel light beam shines from one side at a very small angle α, yet the ambient light can shine from any direction but the direction of the oblique projection onto the screen, because on that side we have the cylindrical mirror (7), and we can design the structure of the screen such that the obliquely projected light will be reflected to the same side of, but perpendicular to, the screen, while at the same time absorbing most of the ambient light or reflecting them to outside the viewer's angle of vision. This is different than the common front projection, as the oblique projection screen not only has high light efficiency, but also good contrast ratio even in strong ambient light conditions.

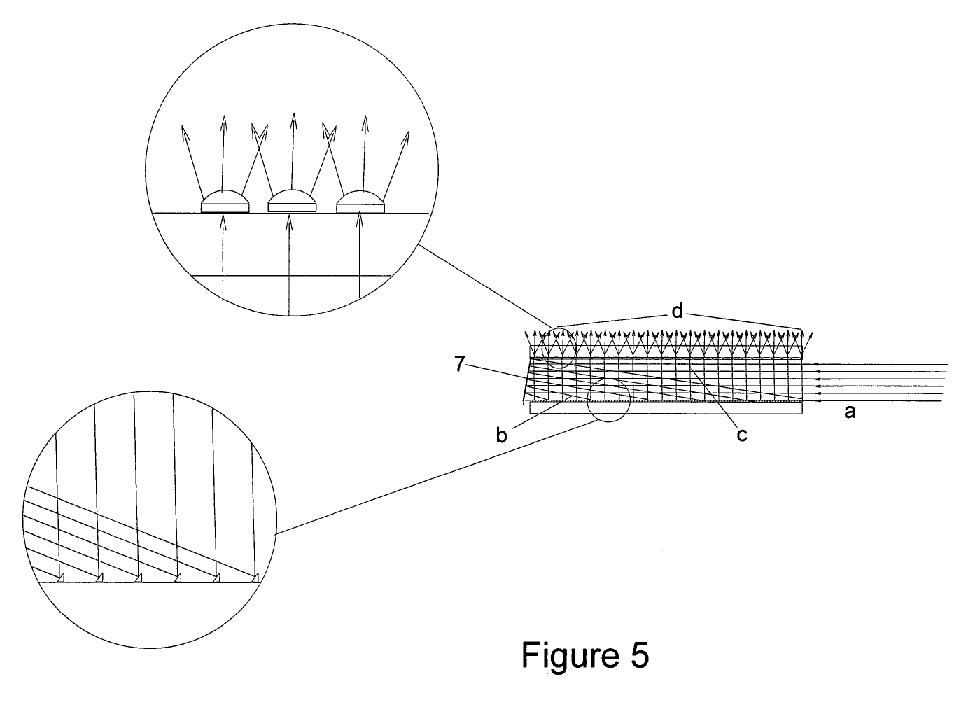

Front oblique projection screen: FIG. 5 is a possible structure for a front oblique projection screen. Incident ray a shines to cylindrical mirror (7) to become obliquely projected parallel ray b, and then projected to small fish scale-like reflecting plates, which are at an angle of (45°-α) from the screen. The reflected rays c shines to the inner surface of the front screen, the scattered rays d passing through a transparent media with a defined light absorption, is dispersed at a defined viewing angle, to reach the viewer's eyes. The small fish scale-like reflecting plates (or micro-half sphere reflecteres) have a reflecting surface toward the obliquely projected rays with an incident angle 45°-α/2, but is black at other directions. The surface of the screen is also black. The small fish scale-like reflecting plates can be as small as 10 microns, with a 0.1 mm pitch in the Y direction, but more closely together in the X direction. Many designs can fulfill this requirement, using various materials and processing, and will not be described in this patent.

Rear oblique projection screen: The obliquely projected light and the viewer are on opposite sides of the screen. The following conditions must be satisfied regarding its structure and material: it must allow the majority of the obliquely projected rays to pass through the screen, at a defined viewing angle range, onto the viewer, while absorbing the majority of the ambient light, so that very little will be reflected and scattered onto the viewer's eyes.

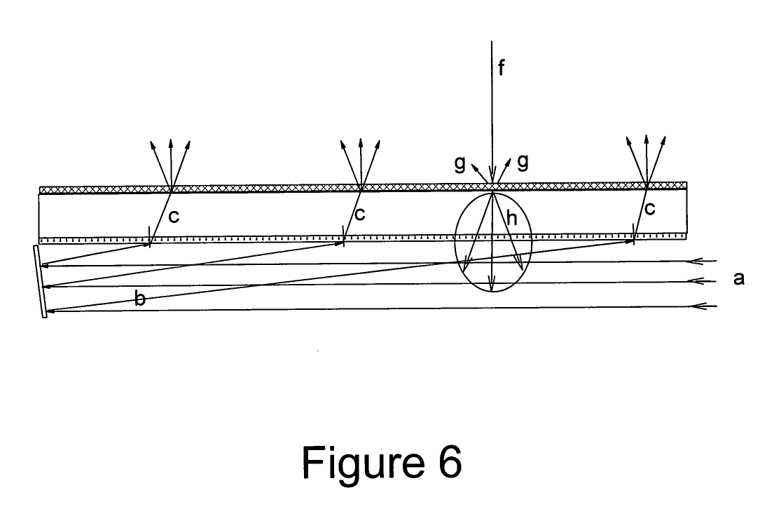

FIG. 6 shows one possible structure. Incident ray a is changed by the cylindrical mirror into parallel light beam b, at an incident angle α onto the oblique projection screen. The beam is almost completely reflected by the micro-prisms and the reflected beams c change the direction to perpendicular to the screen and are then scattering by the micro-half spheres at the front surface of the screen. The scattered rays d are dispersed at a defined viewing angle range to reach the viewer's eyes. Ambient light f reaches the scattering layer, but the majority of the rays h have gone through and been absorbed by the black screen, with only a small part g scattered back out. This structure is relatively simple, and can achieve a good contrast ratio in the presence of ambient light.

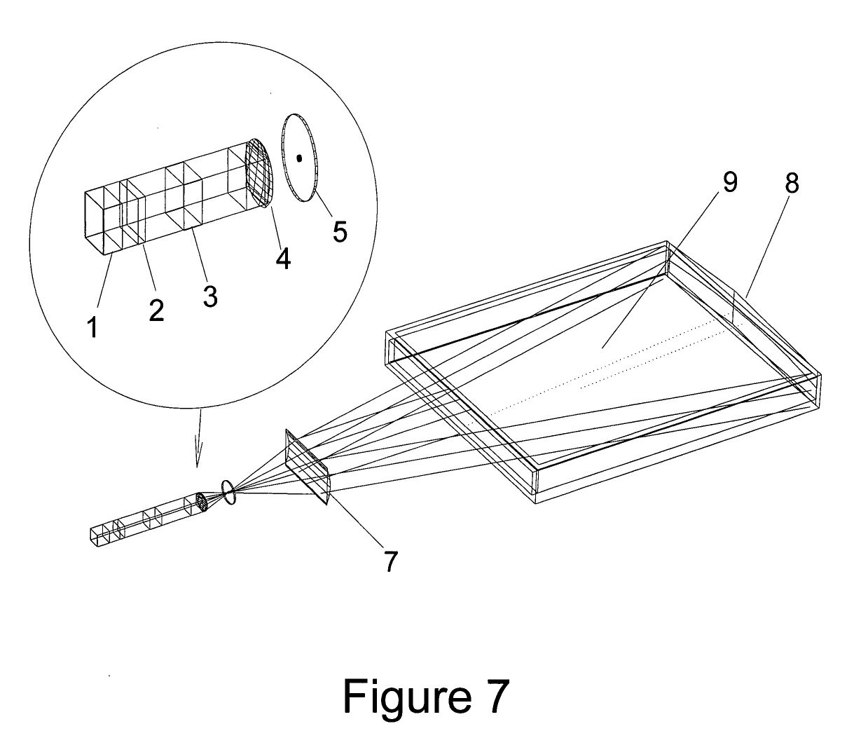

Alternative optical systems: Although this description has dealt primarily with cylindrical optics, lenses and mirrors, other methods of achieving the desired result may be used in this system. FIG. 7 shows a system wherein the rectangular beam from the imager is focused by a spherical lens 4 to a fine point, where it is passed through a small circular aperture 5. A cylindrical lens 7 is placed at the location where the vertical spread of the beam is correct for entering the display cabinet. The effect of this lens is to halt the vertical spread but to allow the beam to spread horizontally until it reaches the end of the cabinet where it is now at the full width of the screen. A cylindrical mirror 8 at this point stops the horizontal spread and the beam strikes the viewing screen system 9 at a small oblique angle as it did in the cylindrical optics systems previously discussed.

1. A system for projection television comprising:
A light source,
An imager,
A device for producing a beam of parallel rays from said light source and imager,
A first optical system which magnifies said beam independently in each of the vertical and horizontal directions,
Vertical and horizontal apertures placed near the focal planes of said first optical system,
A second optical system which converts the magnified beam into a rectangular beam of parallel rays,
An apparatus for directing said rectangular beam into a shallow enclosure at a small vertical angle, and
A viewing screen system that directs the image to the viewer in its proper orientation and size.

2. The system of claim 1 wherein said imager is a LcoS (liquid crystal on silicon).

3. The system of claim 1 wherein said imager is a DMD (digital micromirror device).

4. The system of claim 1 wherein the imager is a P-Si-TFT LCD (liquid crystal display).

5. The system of claim 1 wherein the light source is a laser.

6. The system of claim 1 wherein the light source is a 1i LED(light emitting diode).

7. The system of claim 1 wherein the light source is an UHP (ultra high pressure) source.

8. The system of claim 1 wherein said light source utilizes a color light switch of the type described in published application US2004/0031672A1.

9. The system of claim 1 wherein said first optical system comprises cylindrical lenses.

10. The system of claim 1 wherein said first optical system comprises cylindrical mirrors.

11. The system of claim 1 wherein said second optical system comprises cylindrical lenses.

12. The system of claim 1 wherein said second optical system comprises cylindrical mirrors.

13. The system of claim 1 wherein said viewing screen system comprises a front oblique projection screen.

14. The system of claim 1 wherein said viewing screen comprises a rear projection screen.

15. The system of claim 1 wherein said first optical system is a spherical lens.

16. The system of claim 1 wherein said apertures are a single circular aperture.

17. A method for obtaining a shallow display cabinet in a television system by assembling a system comprising:
A light source,
An imager,
A device for producing a beam of parallel rays from said light source and imager,
A first optical system which magnifies said beam independently in each of the vertical and horizontal directions,
Vertical and horizontal apertures placed near the focal planes of said first optical system,
A second optical system which converts the magnified beam into a rectangular beam of parallel rays,
An apparatus for directing said rectangular beam into a shallow enclosure at a small vertical angle, and
A viewing screen system that directs the image to the viewer in its proper orientation and size.

18. The method of claim 17 wherein said imager is a LcoS (liquid crystal on silicon).

19. The method of claim 17 wherein said imager is a DMD (digital micromirror device).

20. The method of claim 17 wherein the imager is a P-Si-TFT LCD (liquid crystal display).

21. The method of claim 17 wherein the light source is a laser.

22. The method of claim 17 wherein the light source is a LED(light emitting diode).

23. The method of claim 17 wherein the light source is an UHP (ultra high pressure) source.

24. The method of claim 17 wherein said light source utilizes a color light switch of the type described in published application US2004/0031672A1.

25. The method of claim 17 wherein said first optical system comprises cylindrical lenses.

26. The method of claim 17 wherein said first optical system comprises cylindrical mirrors.

27. The method of claim 17 wherein said second optical system comprises cylindrical lenses.

28. The method of claim 17 wherein said second optical system comprises cylindrical mirrors.

29. The method of claim 17 wherein said viewing screen system comprises a front oblique projection screen.

30. The method of claim 17 wherein said viewing screen comprises a rear projection screen.

31. The method of claim 17 wherein said first optical system is a spherical lens.

32. The method of claim 17 wherein said horizontal and vertical apertures are a single circular aperture.
